(19) United States
(12) Patent Application Publication
(10) Pub. No.: US 2025/0224601 A1
(43) Pub. Date: Jul. 10, 2025

(54) OPTICAL MODULE AND ELECTRONIC DEVICE

(71) Applicant: Goertek Optical Technology Co. Ltd., Weifang, Shandong (CN)

(72) Inventor: Hongyou Zheng, Shandong (CN)

(73) Assignee: Goertek Optical Technology Co., Ltd., Weifang, Shandong (CN)

(21) Appl. No.: 18/850,673

(22) PCT Filed: Jun. 27, 2022
(86) PCT No.: PCT/CN2022/101635

§ 371 Date: Sep. 25, 2024

(30) Foreign Application Priority Data
Mar. 31, 2022 (CN) 202210344659.3

(51) Int. Cl. G02B 17/02

(52) U.S. Cl. CPC G02B 17/023

(57) ABSTRACT

The present disclosure provides an optical module and an electronic device. The optical module comprises: an optical path processing assembly and at least two light-emitting displays; wherein, the optical path processing assembly comprises a combined lens and a reflection mirror, the reflection mirror is located on one side of the combined lens, and a surface of the combined lens facing the reflection mirror is provided facing away from an emergent surface of the combined lens.

### CROSS-REFERENCE TO RELATED APPLICATIONS

The present disclosure is a National Stage of International Application No. PCT/CN2022/101635 filed on Jun. 27, 2022, which claims priority to a Chinese patent application No. 202210344659.3 filed with the CNIPA on Mar. 31, 2022, both of which are hereby incorporated by reference in their entireties.

### TECHNICAL FIELD

The present disclosure relates to the technical field of an optical device, and particularly to an optical module and an electronic device.

### BACKGROUND

In the prior art, as shown in FIG. 1, the optical module is mainly composed of a light-emitting display and an X-Plate. The X-Plate has issues concerning its thickness and manufacturing tolerances, which result in degraded image resolution of the light ray emitted from the light-emitting display upon passing through the X-Plate. As may be seen from FIG. 1, the light ray emitted from the light-emitting display located below the X-Plate passes through the edge of the X-Plate with an optical distance of 2 A. However, at the position boxed in FIG. 1, the optical distance through which the light ray emitted from the light-emitting display decreases gradually, and the optical distance gradually decreases from 2 A to 1 A, so that the optical distance through which the light rays emitted from the light-emitting display varies, thereby affecting the imaging quality.

Additionally, as shown in FIG. 1, the X-Plate is composed of two shorter pieces of flat glass bonded to a longer piece of flat glass. For example, the two shorter pieces of flat glass comprise a first short plate 01 and a second short plate 02, while the longer piece of flat glass is the first long plate 03. The first short plate 01 and the second short plate 02 may produce angular tolerances during the bonding process, and the light ray emitted from the light-emitting display may be affected by assembly tolerances, leading to a reduction in resolution.

### SUMMARY

An objective of the present disclosure is to provide new technical solution for an optical module and an electronic device.

According to a first aspect of embodiments of the present disclosure, an optical module is provided. The optical module comprises: an optical path processing assembly and at least two light-emitting displays;

the optical path processing assembly comprises a combined lens and a reflection mirror, the reflection mirror is located on one side of the combined lens, and a surface of the combined lens facing the reflection mirror is provided facing away from an emergent surface of the combined lens;

a light ray emitted from one of the light-emitting displays passes through the optical path processing assembly to be emitted from the emergent surface, forming a first optical path within the optical path processing assembly; a light ray emitted from another one of the light-emitting displays passes through the optical path processing assembly to be emitted from the emergent surface, forming a second optical path within the optical path processing assembly, wherein an optical distance of the first optical path is equal to that of the second optical path.

Optionally, the optical module comprises three light-emitting displays, which comprise a first light-emitting display, a second light-emitting display, and a third light-emitting display; the combined lens has a first incident surface, a second incident surface, and a third incident surface;

the first light-emitting display is in the proximity of the first incident surface, and the first incident surface is adjacent to and perpendicular to the emergent surface;

the second light-emitting display is in the proximity of the second incident surface, and the second incident surface is parallel to the first incident surface;

the third light-emitting display is in the proximity of the third incident surface, and the third incident surface is adjacent to and parallel to the emergent surface.

Optionally, the optical module comprises three light-emitting displays, which comprise a first light-emitting display, a second light-emitting display, and a third light-emitting display; the combined lens has a first incident surface, a second incident surface, and a third incident surface;

the first light-emitting display is in the proximity of the first incident surface, and the first incident surface is adjacent to and perpendicular to the emergent surface;

the second light-emitting display is in the proximity of the second incident surface, and the second incident surface is parallel to the first incident surface;

the third light-emitting display is in the proximity of the third incident surface, and the third incident surface is adjacent to and parallel to the surface of the combined lens facing the reflection mirror.

Optionally, the combined lens comprises a first prism and a second prism which are arranged in a mutually attached manner, and each of the first prism and second prism is respectively formed by gluing hypotenuse surfaces of two right-angle triangular prisms;

glued hypotenuse surfaces of the first prism form an angle with those of the second prism.

Optionally, the combined lens comprises a first prism and a second prism which are arranged in a mutually attached manner, and each of the first prism and second prism is respectively formed by gluing hypotenuse surfaces of two right-angle triangular prisms;

glued hypotenuse surfaces of the first prism are parallel to those of the second prism.

Optionally, the first prism comprises a first right-angle triangular prism and a second right-angle triangular prism, the hypotenuse surface of the first right-angle triangular prism is provided with a first film layer, and the hypotenuse surface of the second right-angle triangular prism is provided with a second film layer;

the second prism comprises a third right-angle triangular prism and a fourth right-angle triangular prism, the hypotenuse surface of the third right-angle triangular prism is provided with a third film layer, and the hypotenuse surface of the fourth right-angle triangular prism is provided with a fourth film layer.

Optionally, the combined lens further comprises a first compensating lens, which is provided on the first incident surface and/or on the surface of the combined lens facing the reflection mirror;

the combined lens further comprises a second compensating lens, which is provided in an optical path of the second light-emitting display and in an optical path of the third light-emitting display.

Optionally, the combined lens comprises a first prism and a second prism which are arranged in a mutually attached manner, and the second compensating lens is provided between the first prism and the second prism.

Optionally, the combined lens further comprises a first compensating lens, which is provided on the first incident surface and/or on the surface of the combined lens facing the reflection mirror;

the combined lens further comprises a third compensating lens, which is provided on the second incident surface;

the combined lens further comprises a fourth compensating lens, which is provided on the third incident surface.

Optionally, the first compensating lens comprises a first polarizer provided on the first incident surface, and a first phase retarder provided on the surface of the combined lens facing the reflection mirror; the first polarizer has a thickness of T1 mm, and the first phase retarder has a thickness of T2 mm; the second compensating lens has a thickness of T1 mm+2T2 mm.

Optionally, the first compensating lens comprises a first polarizer provided on the first incident surface, and a first phase retarder provided on the surface of the combined lens facing the reflection mirror; the first polarizer has a thickness of T1 mm, and the first phase retarder has a thickness of T2 mm; the third compensating lens has a thickness of T1 mm+2T2 mm; the fourth compensating lens has a thickness of T1 mm+2T2 mm.

Optionally, the combined lens is composed of a first flat glass and a second flat glass which form an angle therebetween, and one end of the first flat glass is attached to one end of the second flat glass.

Optionally, each of the first flat glass and the second flat glass is provided with a film layer.

Optionally, the optical path processing assembly further comprises an adjustment lens in the proximity of the emergent surface.

According to a second aspect of the present disclosure, an electronic device is provided. The electronic device comprises a lens and the optical module as described in the first aspect, and the lens is provided in the proximity of the emergent surface.

In the embodiment of the present disclosure, an optical module is provided, and the optical module comprises a combined lens, a reflection mirror and at least two light-emitting displays. After the light rays emitted from different light-emitting displays pass through an optical processing component, different rays travel through equal optical distance, which increases image resolution and improves imaging quality.

Other features and advantages thereof of the present disclosure will become clear by the following detailed description of exemplary embodiments of the present disclosure with reference to the accompanying drawings.

### BRIEF DESCRIPTION OF THE DRAWINGS

In order to illustrate the technical solution of the present disclosure more clearly, the accompanying drawings that need to be used in the embodiments will be briefly described below. It should be understood that the following drawings show only some embodiments of the present disclosure and should not be regarded as limiting the scope. For those skilled in the art, other relevant drawings can also be obtained based on these drawings without creative labor.

FIG. 1 shows a structural schematic diagram of an optical module in the prior art.

FIG. 2 shows a first structural schematic diagram of an optical module in the embodiment of the present disclosure.

FIG. 3 shows a schematic diagram of an optical path of a first light-emitting display in the embodiment of the present disclosure.

FIG. 4 shows a schematic diagram of an optical path of a second light-emitting display in the embodiment of the present disclosure.

FIG. 5 shows a schematic diagram of an optical path of a third light-emitting display in the embodiment of the present disclosure.

FIG. 6 shows a second structural schematic diagram of the optical module in the embodiment of the present disclosure.

FIG. 7 shows a third structural schematic diagram of the optical module in the embodiment of the present disclosure.

FIG. 8 shows a fourth structural schematic diagram of the optical module in the embodiment of the present disclosure.

FIG. 9 shows a fifth structural schematic diagram of the optical module in the embodiment of the present disclosure.

FIG. 10 shows a sixth structural schematic diagram of the optical module in the embodiment of the present disclosure.

### DESCRIPTION OF REFERENCE SIGNS

1, combined lens; 10, emergent surface; 11, first incident surface; 12, second incident surface; 13, third incident surface; 14, first prism; 15, second prism; 141, first right-angle triangular prism; 142, second right-angle triangular prism; 151, third right-angle triangular prism; 152, fourth right-angle triangular prism; 1411, first film layer; 1421, second film layer; 1511, third film layer; 1521, fourth film layer; 16, first flat glass; 17, second flat glass;
2, reflection mirror;
31, first light-emitting display; 32, second light-emitting display; 33, third light-emitting display;
4, first compensating lens; 41, first polarizer; 42, first phase retarder;
5, second compensating lens; 51, second polarizer; 52, second phase retarder;
6, third compensating lens; 61, third polarizer; 62, third phase retarder;
7, fourth compensating lens; 71, fourth polarizer; 72, fourth phase retarder;
8, adjustment lens; 9, lens;
01, first short plate; 02, second short plate; 03, first long plate.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

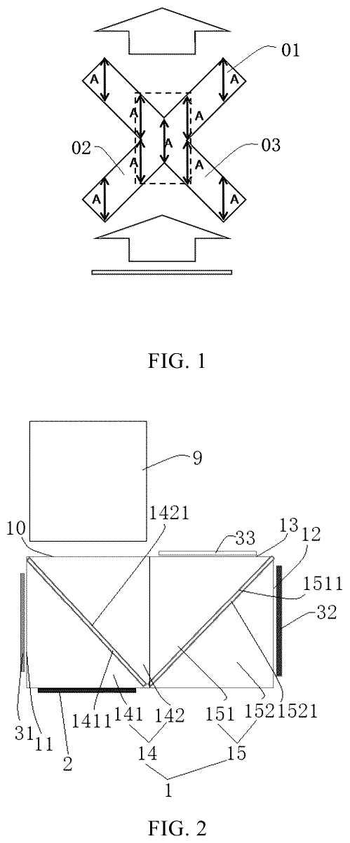

The present disclosure provides an optical module that addresses the technical issue of low image resolution and poor imaging quality due to use of the optical module (an optical module composed of the light-emitting display and the X-Plate) as shown in FIG. 1 in the prior art.

Referencing FIGS. 2 to 10, the optical module comprises: an optical path processing assembly and at least two light-emitting displays. The optical path processing assembly comprises a combined lens 1 and a reflection mirror 2, the reflection mirror 2 being located on one side of the combined lens 1, and a surface of the combined lens 1 facing the reflection mirror 2 being provided facing away from an emergent surface 10 of the combined lens 1, that is, the light ray reflected by the reflection mirror 2 passing through the combined lens 1 and being emitted from the emergent surface 10. A light ray emitted from one of the light-emitting displays passes through the optical path processing assembly to be emitted from the emergent surface 10 of the combined lens 1, forming a first optical path within the optical path processing assembly. The light ray emitted from another one of the light-emitting displays passes through the optical path processing assembly to be emitted from the emergent surface 10 of the combined lens 1, forming a second optical path within the optical path processing assembly, wherein the optical distance of the first optical path is equal to that of the second optical path.

In the present embodiment, the optical path processing assembly processes the light ray emitted from the light-emitting displays, that is, the optical path processing assembly reflects or transmits the light ray emitted from the light-emitting displays. The optical path processing assembly comprises the combined lens 1 and the reflection mirror 2, which together form the optical path processing assembly. The reflection mirror 2 is located on one side of the combined lens 1 to transmit the light ray reflected by the reflection mirror 2 through the combined lens 1 to the emergent surface 10. In use, a lens 9 is provided on one side of the emergent surface 10, so that the reflection mirror 2 is provided facing away from the lens 9, so as to transmit the light ray reflected by the reflection mirror 2 through the combined lens 1 to the lens 9.

In the present embodiment, the optical path processing assembly comprises the combined lens 1 and the reflection mirror 2, and the reflection mirror 2 changes the path of the light ray emitted from the light-emitting displays to extend the path of the light-emitting displays adjacent to the emergent surface 10, avoiding the direct transmission of the light ray emitted from the light-emitting displays adjacent to the emergent surface 10 to the emergent surface 10, thereby avoiding the inconsistency of the optical distances traversed by the light ray emitted from different light-emitting displays. In a specific embodiment, the light-emitting display may be a micro-LED display.

In the present embodiment, at least two light-emitting displays may be located on different sides or the same side of the combined lens 1, and positions of different light-emitting displays may be flexibly arranged according to the structure of the combined lens 1 and the arrangement position of the reflection mirror 2.

As shown in FIGS. 2 to 7, different light-emitting displays are located on different sides of the combined lens 1, that is, the light rays emitted from at least two light-emitting displays enter the combined lens 1 from different sides thereof and are transmitted. For example, in one embodiment, the light ray emitted from the light-emitting display is only transmitted through the combined lens 1, is transmitted through the combined lens 1 to the emergent surface 10, and is then transmitted to the lens 9. Alternatively, in another embodiment, the light ray emitted from the light-emitting display is transmitted through both the combined lens 1 and the reflection mirror 2, and after being transmitted through the combined lens 1 and the reflection mirror 2, it is transmitted to the emergent surface 10, and then transmitted to the lens 9. Regardless of whether the light ray emitted from the light-emitting display is transmitted through only the combined lens 1 or through both the combined lens 1 and the reflection mirror 2, the optical distances traversed by the light rays from different light-emitting displays within the optical path processing assembly are consistent.

In the prior art, the focusing positions are different when the light ray passes through the X-Plate area. As shown in FIG. 1, the focal point formed when the optical distance traversed by the light ray emitted from the light-emitting display is 2A is different from the focal point formed when the optical distance is IA, which naturally affects the imaging quality.

In the present embodiment, the optical distances traversed by the light ray emitted from different light-emitting displays after passing through the optical path processing assembly are equal, which avoids the problem in the prior art that the focusing positions are different when the light ray emitted from the light-emitting displays passes through the X-Plate area, thereby enhancing the imaging quality and image resolution.

In one embodiment, as shown in FIGS. 2 to 9, the optical module comprises three light-emitting displays, which comprise: a first light-emitting display 31, a second light-emitting display 32, and a third light-emitting display 33. The combined lens 1 has a first incident surface 11, a second incident surface 12, and a third incident surface 13.

The first light-emitting display 31 is in the proximity of the first incident surface 11, and the first incident surface 11 is adjacent to and perpendicular to the emergent surface 10. That is, the first incident surface 11 is adjacent to and perpendicular to the surface of the combined lens 1 facing the reflection mirror 2. In other words, the first band of ray emitted from the first light-emitting display 31 enters the combined lens 1 from the first incident surface 11. In the absence of the reflection mirror 2, the first band of ray emitted from the first light-emitting display 31 could be directly transmitted to the emergent surface 10, or the first band of ray might be directly transmitted to the outside of the combined lens 1.

In the present embodiment, due to the positional relationship of the first incident surface 11, to ensure that the optical distance traversed by the first band of ray emitted from the first light-emitting display 31 is equal to the optical distance traversed by the second band of ray emitted from the second light-emitting display 32, and to ensure that the optical distance traversed by the first band of ray emitted from the first light-emitting display 31 is equal to the optical distance traversed by the third band of ray emitted from the third light-emitting display 33, a reflection mirror 2 is provided in the proximity of the surface facing away from the emergent surface 10. After the first band of ray emitted from the first light-emitting display 31 enters the combined lens 1 through the first incident surface 11, it first is transmitted to the reflection mirror 2, is reflected by the reflection mirror 2, re-enters the combined lens 1, and is ultimately transmitted through the emergent surface 10 to the lens 9.

In the present embodiment, the second light-emitting display 32 is in the proximity of the second incident surface 12, and the second incident surface 12 is parallel to the first incident surface 11; that is, the first and second incident surfaces 11 and 12 are parallel in the length direction of the combined lens 1, and in other words, the second incident surface 12 is provided further away from the emergent surface 10 relative to the first incident surface 11. In order to ensure that the optical distance traversed by the second band of ray emitted from the second light-emitting display 32 is equal to the optical distance traversed by the first band of ray emitted from the first light-emitting display 31, and to ensure that the optical distance traversed by the second band of ray emitted from the second light-emitting display 32 is equal to the optical distance traversed by the third band of ray emitted from the third light-emitting display 33, the second band of ray emitted from the second light-emitting display 32, after entering the combined lens 1 through the second incident surface 12, is transmitted along the length direction of the combined lens 1, is then transmitted to the emergent surface 10 after reflected once by the combined lens 1, and is finally transmitted into the lens 9 through the emergent surface 10.

In the present embodiment, the third light-emitting display 33 is in the proximity of the third incident surface 13, and the third incident surface 13 is adjacent to and parallel to the emergent surface 10. That is, the third incident surface 13 is perpendicular to both the first and second incident surfaces 11 and 12. Since the third incident surface 13 is parallel to the emergent surface 10, to ensure that the third band of ray emitted by the third incident surface 13 may be transmitted to the emergent surface 10, the third band of ray needs to be reflected and transmitted to the emergent surface 10 after entering the combined lens 1 through the third incident surface 13. To ensure that the optical distance traversed by the third band of ray emitted from the third light-emitting display 33 is equal to the optical distance traversed by the first band of ray emitted from the first light-emitting display 31, and to ensure that the optical distance traversed by the third band of ray emitted from the third light-emitting display 33 is equal to the optical distance traversed by the second band of ray emitted from the second light-emitting display 32, the third band of ray emitted from the third light-emitting display 33, after entering the combined lens 1 through the third incident surface 13. is transmitted to the emergent surface 10 after reflected twice by the combined lens 1, and is finally transmitted to the lens 9 through the emergent surface 10.

The present embodiment defines positions for providing the first light-emitting display 31, the second light-emitting display 32, and the third light-emitting display 33, which ensures that the optical distance traversed by the first band of ray emitted from the first light-emitting display 31 is equal to the optical distance traversed by the second band of ray emitted from the second light-emitting display 32, and also equal to the optical distance traversed by the third band of ray emitted from the third light-emitting display 33. In the present embodiment, the optical distances formed by the light rays emitted from the first, second, and third light-emitting displays are consistent, which enhances image resolution and imaging quality.

In one embodiment, as shown in FIG. 10, the optical module comprises three light-emitting displays, which comprise a first light-emitting display 31, a second light-emitting display 32, and a third light-emitting display 33; the combined lens 1 has a first incident surface 11, a second incident surface 12, and a third incident surface 13; the first light-emitting display 31 is in the proximity of the first incident surface 11, and the first incident surface 11 is adjacent to and perpendicular to the emergent surface 10; the second light-emitting display 32 is in the proximity of the second incident surface 12, and the second incident surface 12 is parallel to the first incident surface 11; the third light-emitting display 33 is in the proximity of the third incident surface 13, and the third incident surface 13 is adjacent to and parallel to the surface of the combined lens 1 facing the reflection mirror 2.

In the present embodiment, the transmission path of the first band of ray emitted from the first light-emitting display 31 is consistent with the transmission path shown in FIGS. 2 to 6 for the first band of ray emitted from the first light-emitting display 31. The transmission path of the second band of ray emitted from the second light-emitting display 32 is consistent with the transmission path shown in FIGS. 2 to 6 for the second band of ray emitted from the second light-emitting display 32. Wherein, the position for providing the third light-emitting display 33 in the present embodiment is different from the position shown in FIGS. 2 to 7 for the third light-emitting display 33. In the present embodiment, the third light-emitting display 33 and the reflection mirror 2 are provided on the same side. The third band of ray emitted from the third light-emitting display 33, after entering the combined lens 1 through the third incident surface 13, is also transmitted to the emergent surface 10 after reflected twice by the combined lens 1, and is finally transmitted to the lens 9 through the emergent surface 10.

Therefore, in the present disclosure, the positions for providing the first light-emitting display 31, the second light-emitting display 32, and the third light-emitting display 33 are not particularly limited, that is to say, the first light-emitting display 31, the second light-emitting display 32, and the third light-emitting display 33 may be located on different sides of the combined lens 1, or the first light-emitting display 31, the second light-emitting display 32, and the third light-emitting display 33 may be located on the same side of the combined lens 1. In the present disclosure, due to processing of the combined lens 1 and the reflection mirror 2 on the light ray, it is satisfied that the optical distance traversed by the first band of ray is equal to the optical distance traversed by the second band of ray, and also equal to the optical distance traversed by the third band of ray.

In one embodiment, as shown in FIGS. 2 to 5 and FIGS. 7 to 9, the combined lens 1 comprises a first prism 14 and a second prism 15 which are arranged in a mutually attached manner, and each of the first prism 14 and second prism 15 is respectively formed by gluing hypotenuse surfaces of two right-angle triangular prisms; the glued hypotenuse surfaces of the first prism 14 form an angle with those of the second prism 15.

In the present embodiment, the positional relationship between the glued hypotenuse surfaces of the first prism 14 and the glued hypotenuse surfaces of the second prism 15 determines the position for providing the third light-emitting display 33. Specifically, the combined lens I comprises a first prism 14 and a second prism 15 which are arranged in a mutually attached manner, the first prism 14 has the first incident surface 11 and the emergent surface 10, a surface of the second prism 15 parallel to the first incident surface 11 is the second incident surface 12, and a surface of the second prism 15 perpendicular to the second incident surface 12 and parallel to the emergent surface 10 is the third incident surface 13. In order to facilitate the third band of ray emitted from the third light-emitting display 33 to enter the combined lens 1 and be directly reflected by the glued hypotenuse surfaces of the second prism 15, and to ensure that the optical distances traversed by the three bands of ray are consistent, the glued hypotenuse surfaces of the first prism 14 and the glued hypotenuse surfaces of the second prism 15 are provided at an angle to each other.

In a specific embodiment, the first prism 14 is a first cubic prism, and the second prism 15 is a second cubic prism. The combined lens 1 is a rectangular prism, with the length dimension of the combined lens 1 being twice the size of the width dimension. The angle between the glued hypotenuse surfaces of the first prism 14 and the glued hypotenuse surfaces of the second prism 15 is 90°. In the present embodiment, it is more accurate and convenient to ensure that the optical distance traversed by the first band of ray is equal to the optical distance traversed by the second band of ray, as well as to the optical distance traversed by the third band of ray.

In another embodiment, as shown in FIG. 10, the combined lens comprises a first prism 14 and a second prism 15 which are arranged in a mutually attached manner, and each of the first prism 14 and second prism 15 is respectively formed by gluing hypotenuse surfaces of two right-angle triangular prisms; the glued hypotenuse surfaces of the first prism 14 are parallel to those of the second prism 15.

In the present embodiment, the positional relationship between the glued hypotenuse surfaces of the first prism 14 and the glued hypotenuse surfaces of the second prism 15 determines the position for providing the third light-emitting display 33. Specifically, the combined lens 1 comprises a first prism 14 and a second prism 15 which are arranged in a mutually attached manner, the first prism 14 has the first incident surface 11 and the emergent surface 10, a surface of the second prism 15 parallel to the first incident surface 11 is the second incident surface 12, and a surface of the second prism 15 perpendicular to the second incident surface 12 and parallel to the surface facing the reflecting mirror 2 is the third incident surface 13. In order to facilitate the third band of ray emitted from the third light-emitting display 33 to enter the combined lens and be directly reflected by the glued hypotenuse surfaces of the second prism 15, and to ensure that the optical distances traversed by the three bands of ray are consistent, the glued hypotenuse surfaces of the first prism 14 and the glued hypotenuse surfaces of the second prism 15 are parallel to each other.

In one embodiment, as shown in FIGS. 2-5 and FIGS. 7-9, the first prism 14 comprises a first right-angle triangular prism 141 and a second right-angle triangular prism 142, the hypotenuse surface of the first right-angle triangular prism 141 is provided with a first film layer 1411, and the hypotenuse surface of the second right-angle triangular prism 142 is provided with a second film layer 1421.

The second prism 15 comprises a third right-angle triangular prism 151 and a fourth right-angle triangular prism 152, the hypotenuse surface of the third right-angle triangular prism 151 is provided with a third film layer 1511, and the hypotenuse surface of the fourth right-angle triangular prism 152 is provided with a fourth film layer 1521.

In an example, the first film layer 1411 may be applied to the hypotenuse surface of the first right-angle triangular prism 141 by using a lamination or coating process; the second film layer 1421 may be applied to the hypotenuse surface of the second right-angle triangular prism 142 by using the lamination or coating process; the third film layer 1511 may be applied to the hypotenuse surface of the third right-angle triangular prism 151 by using the lamination or coating process; the fourth film layer 1521 may be applied to the hypotenuse surface of the fourth right-angle triangular prism 152 by using the lamination or coating process.

In the present embodiment, the lamination or coating is applied to the hypotenuse surfaces of the right-angle triangular prisms, and there are various types of film layers available, which may be a film layers that allow monochromatic ray to pass through and reflects other rays; or it may be film layers capable of reflecting polychromatic ray. Therefore, different film layers are selected corresponding to the position for providing different light-emitting displays.

For example, as shown in FIG. 2, the hypotenuse surface of the first right-angle triangular prism 141 and the hypotenuse surface of the second right-angle triangular prism 142 are arranged in a mutually attached manner to form the first prism 14. The hypotenuse surface of the third right-angle triangular prism 151 and the hypotenuse surface of the fourth right-angle triangular prism 152 are arranged in a mutually attached manner to form the second prism 15. In an optional embodiment, the first prism 14 may be a first cubic prism, and the second prism 15 may be a second cubic prism. In another optional embodiment, the first prism 14 may be a polarization beam-splitting prism.

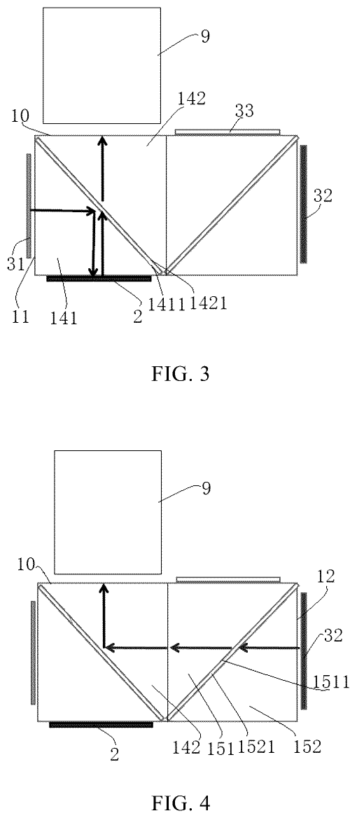

In the present embodiment, as shown in FIG. 3, the reflection mirror 2 is located on one side of the first right-angle triangular prism 141, and the lens 9 is located on one side of the second right-angle triangular prism 142. The first incident surface 11 is adjacent to and perpendicular to the surface of the combined lens 1 facing the reflection mirror 2, as well as adjacent to and perpendicular to the emergent surface 10. The first incident surface 11 is provided on the first right-angle triangular prism 141, and the emergent surface 10 is provided on the second right-angle triangular prism 142.

The first band of ray emitted from the first light-emitting display 31, after entering the first prism 14 through the first incident surface 11, is first reflected to the reflection mirror 2 by the first film layer 1411, then re-enters the first prism 14 after being reflected by the reflection mirror 2, is transmitted through the first film layer 1411 and the second film layer 1421 to the emergent surface 10, and is finally transmitted to the lens 9 through the emergent surface 10. As shown in FIG. 3, the arrow indicates the optical path of the first band of ray emitted from the first light-emitting display 31.

In the present embodiment, as shown in FIG. 4, the second band of ray emitted from the second light-emitting display 32, after entering the second prism 15 through the second incident surface 12, is subsequently transmitted through the fourth film layer 1521 and the third film layer 1511 to the first prism 14, is then to the emergent surface 10 after reflected by the second film layer 1421, and is finally transmitted to the lens 9 through the emergent surface 10. As shown in FIG. 4, the arrows indicate the optical path of the second band of ray emitted from the second light-emitting display 32.

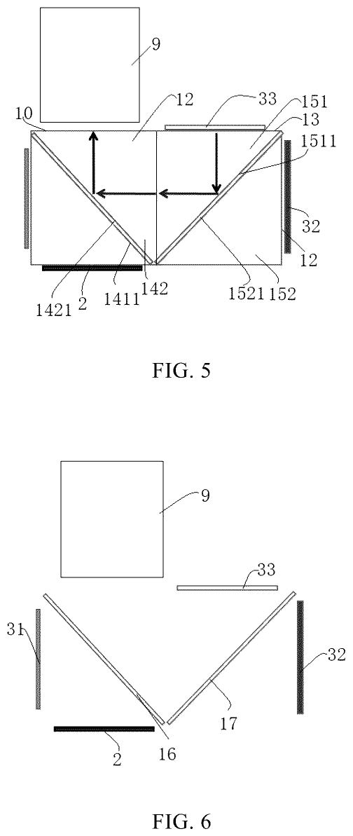

In the present embodiment, as shown in FIG. 5, the third band of ray emitted from the third light-emitting display 33, after entering the third right-angle triangular prism 151 through the third incident surface 13, is first transmitted to the first prism 14 after reflected by the third film layer 1511, then is transmitted to the emergent surface 10 after reflected by the second film layer 1421, and is finally transmitted to the lens 9 through the emergent surface 10. As shown in FIG. 5, the arrows indicate the optical path of the third band of ray emitted from the third light-emitting display. Therefore, the third film layer 1511 is used to reflect the third band of ray and allow the second band of ray to transmit through. Considering the reflection and transmission of different bands of ray by the third film layer 1511, and in combination with the wavelengths of the light ray emitted by the different light-emitting displays, to facilitate the preparation of the third film layer 1511, the second light-emitting display 32 may be a red light-emitting display, the third light-emitting display 33 may be a green light-emitting display, and the first light-emitting display 31 may be a blue light-emitting display; or the second light-emitting display 32 may be a green light-emitting display, the third light-emitting display 33 may be a red light-emitting display, and the first light-emitting display 31 may be a blue light-emitting display.

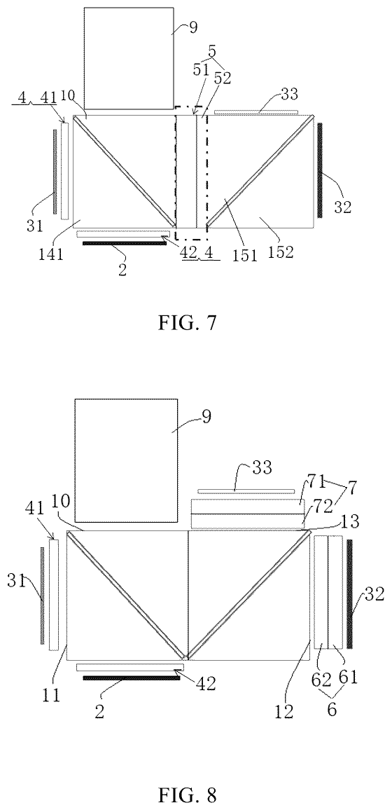

In one embodiment, as shown in FIGS. 7-8, the combined lens 1 further comprises a first compensating lens 4, which is provided on the first incident surface 11 and/or on the surface facing the reflecting mirror 2; the combined lens 1 further comprises a second compensating lens 5, which is provided in an optical path of the second light-emitting display 32 and in an optical path of the third light-emitting display 33.

Specifically, to ensure that the optical distance traversed by the first band of ray emitted from the first light-emitting display 31 is equal to the optical distance traversed by the second band of ray emitted from the second light-emitting display 32, as well as the optical distance traversed by the third band of ray emitted from the third light-emitting display 33, when the first compensating lens 4 is provided on the first incident surface 11 and/or on the surface facing the reflecting mirror 2, the second compensating lens 5 needs to be provided in the optical paths of the second light-emitting display 32 and the third light-emitting display 33.

In a specific embodiment, the combined lens 1 comprises a first prism 14 and a second prism 15 which are arranged in a mutually attached manner, and the second compensating lens 5 is provided between the first prism 14 and the second prism 15.

For example, by providing the first compensating lens 4 on the first incident surface 11 and providing the second compensating lens 5 between the first prism 14 and the second prism 15, with the thicknesses of the first compensating lens 4 and the second compensating lens 5 being equal, it is possible to ensure that the optical distance traversed by the first band of ray emitted from the first light-emitting display 31 is equal to the optical distance traversed by the second band of ray emitted from the second light-emitting display 32, as well as the optical distance traversed by the third band of ray emitted from the third light-emitting display 33.

Alternatively, by providing the first compensating lens 4 on the surface facing the reflecting mirror 2 and providing the second compensating lens 5 between the first prism 14 and the second prism 15, with the thickness of the second compensating lens 5 being twice the thickness of the first compensating lens 4 (since the first band of ray emitted from the first light-emitting display 31, after passing through the first compensating lens 4, is reflected by the reflecting mirror 2, and after reflected by the reflecting mirror 2, then passes through the first compensating lens 4 again to enter the first prism 14), it is possible to ensure that the optical distance traversed by the first band of ray emitted from the first light-emitting display 31 is equal to the optical distance traversed by the second band of ray emitted from the second light-emitting display 32, as well as the optical distance traversed by the third band of ray emitted from the third light-emitting display 33.

Alternatively, by providing the first compensating lens 4 on both the first incident surface 11 and the surface of the reflecting mirror 2, and by providing the second compensating lens 5 between the first prism 14 and the second prism 15, it is possible to ensure that the optical distance traversed by the first band of ray emitted from the first light-emitting display 31 is equal to the optical distance traversed by the second band of ray emitted from the second light-emitting display 32, as well as the optical distance traversed by the third band of ray emitted from the third light-emitting display 33.

In a specific embodiment, the first compensating lens 4 comprises a first polarizer 41 provided on the first incident surface, and a first phase retarder 42 provided on the surface facing the reflecting mirror 2; the first polarizer 41 has a thickness of T1 mm, and the first phase retarder 42 has a thickness of T2 mm; the second compensating lens 5 has a thickness of T1 mm+2T2 mm. For example, the first phase retarder 42 may be a quarter-wave plate.

Referring to FIGS. 7-8, the combined lens 1 comprises a first right-angle triangular prism 141, a second right-angle triangular prism 142, a third right-angle triangular prism 151, and a fourth right-angle triangular prism 152. The first right-angle triangular prism 141 and the second right-angle triangular prism 142 are combined to form the first prism 14, while the third right-angle triangular prism 151 and the fourth right-angle triangular prism 152 are combined to form the second prism 15.

In the present embodiment, the combined lens 1 further comprises the first polarizer 41 and the first phase retarder 42, the first polarizer 41 is provided between the first light-emitting display 31 and the first prism 14 (the first polarizer 41 may be provided the first incident surface 11), and the first phase retarder 42 is provided between the reflecting mirror 2 and the first prism 14 (the first phase retarder 42 may be provided on the surface facing the reflecting mirror 2).

In the present embodiment, the first band of ray emitted from the first light-emitting display 31 enters the first right-angle triangular prism 141 through the first polarizer 41, is reflected by the first film layer 1411, then passes through the first phase retarder 42 to be transmitted to the reflecting mirror 2, is reflected by the reflecting mirror 2, again passes through the first phase retarder 42 to be transmitted to the first right-angle triangular prism 141, enters the second right-angle triangular prism 142 after transmitting through the first film layer 1411 and the second film layer 1421, and is finally received by the lens 9 through the emergent surface 10.

To ensure that the optical distance traversed by the second band of ray emitted from the second light-emitting display 32 and the optical distance traversed by the third band of ray emitted from the third light-emitting display 33 are equal to the optical distance traversed by the first band of ray emitted from the first light-emitting display 31, the second compensating lens 5 is provided in the optical paths of the second light-emitting display 32 and the third light-emitting display 33. The second compensating lens 5 comprises the second polarizer 51 and the second phase retarder 52.

For example, the second light-emitting display 32 and the third light-emitting display 33 may share the second polarizer 51 and the second phase retarder 52 so that the optical distance traversed by the second band of ray emitted from the second light-emitting display 32 and the optical distance traversed by the third band of ray emitted from the third light-emitting display 33 are both equal to the optical distance traversed by the first band of ray emitted from the first light-emitting display 31.

Specifically, in one embodiment, as shown in FIG. 7, the second compensating lens 5 is provided between the first prism 14 and the second prism 15, and comprises the second polarizer 51 and the second phase retarder 52. After the second band of ray emitted from the second light-emitting display 32 and the third band of ray emitted from the third light-emitting display 33 are transmitted through the second polarizer 51 and the second phase retarder 52, they enter the first prism 14, are transmitted to the outside of the emergent surface 10 after reflected by the second film layer 1421, and are finally received by the lens 9.

In the present embodiment, it is necessary to ensure that the total thickness of the second polarizer 51 and the second phase retarder 52 is T1 mm+2T2 mm, so as to ensure that the optical distance traversed by the first band of ray emitted from the first light-emitting display 31 is equal to both the optical distance traversed by the second band of ray emitted from the second light-emitting display 32 and the optical distance traversed by the third band of ray emitted from the third light-emitting display 33.

In one embodiment, as shown in FIG. 8, the combined lens 1 further comprises a first compensating lens 4, which is provided on the first incident surface 11 and/or on the surface facing the reflecting mirror 2. The combined lens 1 further comprises a third compensating lens 6, which is provided on the second incident surface 12. The combined lens 1 further comprises a fourth compensating lens 7, which is provided on the third incident surface 13.

In a specific embodiment, the first compensating lens 4 is provided on the first incident surface 11, the third compensating lens 6 is provided on the second incident surface 12, and the fourth compensating lens 7 is provided on the third incident surface 13. The thickness of the first compensating lens 4 is equal to both the thickness of the third compensating lens 6 and the thickness of the fourth compensating lens 7, so as to ensure that the optical distance traversed by the first band of ray emitted from the first light-emitting display 31 is equal to both the optical distance traversed by the second band of ray emitted from the second light-emitting display 32 and the optical distance traversed by the third band of ray emitted from the third light-emitting display 33.

Alternatively, the first compensating lens 4 is provided on the surface facing the reflecting mirror 2, the third compensating lens 6 is provided on the second incident surface 12, and the fourth compensating lens 7 is provided on the third incident surface 13. In this case, it is necessary to define the thickness of the third compensating lens 6 to twice the thickness of the first compensating lens 4, and to define the thickness of the fourth compensating lens 7 to twice the thickness of the first compensating lens 4 (since the first band of ray emitted from the first light-emitting display 31 is reflected by the reflecting mirror 2 after passing through the first compensating lens 4, is reflected by the reflecting mirror 2, and then re-enters the first prism 14 after again passing through the first compensating lens 4), so as to ensure that the optical distance traversed by the first band of ray emitted from the first light-emitting display 31 is equal to both the optical distance traversed by the second band of ray emitted from the second light-emitting display 32 and the optical distance traversed by the third band of ray emitted from the third light-emitting display 33.

Alternatively, the first compensating lens 4 is provided on both the first incident surface 11 and the surface of the reflecting mirror 2, the third compensating lens 6 is provided on the second incident surface 12, and the fourth compensating lens 7 is provided on the third incident surface 13, so as to ensure that the optical distance traversed by the first band of ray emitted from the first light-emitting display 31 is equal to both the optical distance traversed by the second band of ray emitted from the second light-emitting display 32 and the optical distance traversed by the third band of ray emitted from the third light-emitting display 33.

In one embodiment, the first compensating lens 4 comprises a first polarizer 41 provided on the first incident surface 11, and a first phase retarder 42 provided on the surface facing the reflecting mirror 2; the first polarizer 41 has a thickness of T1 mm, and the first phase retarder 42 has a thickness of T2 mm; the third compensating lens 6 has a thickness of T1 mm+2T2 mm; the fourth compensating lens 7 has a thickness of T1 mm+2T2 mm.

In a specific implementation, to ensure that both the optical distance traversed by the second band of ray emitted from the second light-emitting display 32 and the optical distance traversed by the third band of ray emitted from the third light-emitting display 33 are equal to the optical distance traversed by the first band of ray emitted from the first light-emitting display 31, the third compensating lens 6 is provided in the optical path of the second light-emitting display 32, and comprises the third polarizer 61 and a third phase retarder 62, while the fourth compensating lens 7 is provided in the optical path of the third light-emitting display 33, and comprises the fourth polarizer 71 and the fourth phase retarder 72.

Specifically, as shown in FIG. 8, the third polarizer 61 and the third phase retarder 62 are provided between the second light-emitting display 32 and the fourth right-angle triangular prism 152, while the fourth polarizer 71 and the fourth phase retarder 72 are provided between the third light-emitting display 33 and the third right-angle triangular prism 151, so as to ensure that the optical distance traversed by the second band of ray emitted from the second light-emitting display 32 and the optical distance traversed by the third band of ray emitted from the third light-emitting display 33 are both equal to the optical distance traversed by the first band of ray emitted from the first light-emitting display 31. In the present embodiment, it is necessary to ensure that the total thickness of the third polarizer 61 and the third phase retarder 62 is T1 mm+2T2 mm, and the total thickness of the fourth polarizer 71 and the fourth phase retarder 72 is T1 mm+2T2 mm, so as to ultimately ensure that the optical distance traversed by the first band of ray emitted from the first light-emitting display 31 is equal to the optical distance traversed by the second band of ray emitted from the second light-emitting display 32 and the optical distance traversed by the third band of ray emitted from the third light-emitting display 33.

In one embodiment, as shown in FIG. 6, the combined lens 1 is composed of a first flat glass 16 and a second flat glass 17 which form an angle therebetween, and one end of the first flat glass 16 is attached to one end of the second flat glass 17.

In the present embodiment, the combined lens 1 is composed of the first flat glass 16 and the second flat glass 17 which form an angle therebetween. In one optional embodiment, there is an angle of 90° between the first flat glass 16 and the second flat glass 17, so as to make the length dimension of the combined lens 1 twice the width dimension of the combined lens 1, ensuring that the optical distance traversed by the first band of ray emitted from the first light-emitting display 31 is equal to the optical distance traversed by the second band of ray emitted from the second light-emitting display 32 and equal to the optical distance traversed by the third band of ray emitted from the third light-emitting display 33. In the manufacturing process of the combined lens 1, one end of the first flat glass 16 is bonded to one end of the second flat glass 17, thereby avoiding the tilting error in the prior art that occurs when two shorter flat glass are bonded.

In a specific embodiment, the reflecting mirror 2 and the first light-emitting display 31 are provided adjacent to the first flat glass 16, and are perpendicular to each other. The second light-emitting display 32 and the third light-emitting display 33 are positioned adjacent to the second flat glass 17 and are perpendicular to each other.

In one embodiment, both the first flat glass 16 and the second flat glass 17 are provided with a film layer.

In the present embodiment, both the first flat glass 16 and the second flat glass 17 is provided with a film layer, such that the first band of ray emitted from the first light-emitting display 31, the second band of ray emitted from the second light-emitting display 32, and the third band of ray emitted from the third light-emitting display 33 may be transmitted after entering the combined lens 1, while ensuring that the optical distances of the first band of ray emitted from the first light-emitting display 31, the second band of ray emitted from the second light-emitting display 32, and the third band of ray emitted from the third light-emitting display 33 are equal.

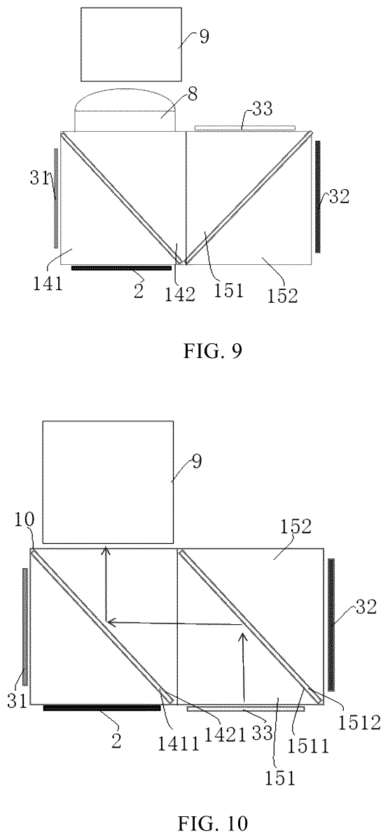

In one embodiment, as shown in FIG. 9, the optical path processing assembly further comprises an adjustment lens 8 in the proximity of the emergent surface 10.

In the present embodiment, the optical path processing assembly further comprises an adjustment lens 8, which is used to adjust the light ray entering the lens 9, i.e., the adjustment lens 8 is used to process the light ray from the first light-emitting display 31 entering the lens 9, the light ray from the second light-emitting display 32 entering the lens 9, and the light ray from the third light-emitting display 33 entering the lens 9. For example, the adjustment lens 8 may be a collimating lens, and may be made of glass or plastic.

According to a second aspect of the present disclosure, an electronic device is provided. The electronic device comprises a lens 9 and the optical module as described in the first aspect, with the lens 9 provided in the proximity of the emergent surface 10. In the present embodiment, the optical module is applied to the electronic device, thereby improving the imaging picture and picture resolution of the electronic device.

The above embodiments focus on the differences between the embodiments, and the different optimization features between the embodiments may be combined to form a better embodiment as long as they are not contradictory, and in consideration of the conciseness, they will not be further elaborated herein.

Although the present disclosure has been described in detail in connection with some specific embodiments by way of illustration, those skilled in the art should understand that the above examples are provided for illustration only and should not be taken as a limitation on the scope of the disclosure. Those skilled in the art will appreciate that modifications may be made to the above embodiments without departing from the scope and spirit of the present disclosure. We therefore claim as our disclosure all that comes within the scope of the appended claims.

1. An optical module, characterized by comprising: an optical path processing assembly and at least two light-emitting displays;
wherein, the optical path processing assembly comprises a combined lens and a reflection mirror, the reflection mirror is located on one side of the combined lens, and a surface of the combined lens facing the reflection mirror is provided facing away from an emergent surface of the combined lens; and
a first light ray emitted from one of the light-emitting displays is configured to pass through the optical path processing assembly to be emitted from the emergent surface, forming a first optical path within the optical path processing assembly; a second light ray emitted from another of the light-emitting displays is configured to passes through the optical path processing assembly to be emitted from the emergent surface, forming a second optical path within the optical path processing assembly, wherein an optical distance of the first optical path is equal to that of the second optical path.

2. The optical module of claim 1, wherein the at least two light-emitting displays comprises a first light-emitting display, a second light-emitting display, and a third light-emitting display; the combined lens has a first incident surface, a second incident surface, and a third incident surface;
the first light-emitting display is in the proximity of the first incident surface, and the first incident surface is adjacent to and perpendicular to the emergent surface;
the second light-emitting display is in the proximity of the second incident surface, and the second incident surface is parallel to the first incident surface; and
the third light-emitting display is in the proximity of the third incident surface, and the third incident surface is adjacent to and parallel to the emergent surface

3. The optical module of claim 1, wherein the at least two light-emitting displays comprises a first light-emitting display, a second light-emitting display, and a third light-emitting display; the combined lens has a first incident surface, a second incident surface, and a third incident surface;
the first light-emitting display is in the proximity of the first incident surface, and the first incident surface is adjacent to and perpendicular to the emergent surface;
the second light-emitting display is in the proximity of the second incident surface, and the second incident surface is parallel to the first incident surface; and
the third light-emitting display is in the proximity of the third incident surface, and the third incident surface is adjacent to and parallel to the surface of the combined lens facing the reflection mirror.

4. The optical module of claim 2, wherein the combined lens comprises a first prism and a second prism arranged in a mutually attached manner, and each of the first prism and second prism is respectively formed by gluing hypotenuse surfaces of two right-angle triangular prisms; and
the glued hypotenuse surfaces of the first prism form an angle with those of the second prism.

5. The optical module of claim 3, wherein the combined lens comprises a first prism and a second prism arranged in a mutually attached manner, and each of the first prism and second prism is respectively formed by gluing hypotenuse surfaces of two right-angle triangular prisms; and
the glued hypotenuse surfaces of the first prism are parallel to those of the second prism.

6. The optical module of claim 4, wherein the first prism comprises a first right-angle triangular prism and a second right-angle triangular prism, the hypotenuse surface of the first right-angle triangular prism is provided with a first film layer, and the hypotenuse surface of the second right-angle triangular prism is provided with a second film layer; and
the second prism comprises a third right-angle triangular prism and a fourth right-angle triangular prism, the hypotenuse surface of the third right-angle triangular prism is provided with a third film layer, and the hypotenuse surface of the fourth right-angle triangular prism is provided with a fourth film layer.

7. The optical module of claim 2, wherein the combined lens further comprises a first compensating lens, which is provided on the first incident surface and/or on the surface of the combined lens facing the reflection mirror; and
the combined lens further comprises a second compensating lens, which is provided in on an optical path of the second light-emitting display and on an optical path of the third light-emitting display.

8. The optical module of claim 7, wherein the combined lens comprises a first prism and a second prism arranged in a mutually attached manner, and the second compensating lens is provided between the first prism and the second prism.

9. The optical module of claim 2, wherein the combined lens further comprises a first compensating lens, which is provided on the first incident surface and/or on the surface of the combined lens facing the reflection mirror;
the combined lens further comprises a third compensating lens, which is provided on the second incident surface; and
the combined lens further comprises a fourth compensating lens, which is provided on the third incident surface.

10. The optical module of claim 8, wherein the first compensating lens comprises a first polarizer provided on the first incident surface, and a first phase retarder provided on the surface of the combined lens facing the reflection mirror; the first polarizer has a thickness of T1 mm, and the first phase retarder has a thickness of T2 mm; and
the second compensating lens has a thickness of T1 mm+2T2 mm.

11. The optical module of claim 9, wherein the first compensating lens comprises a first polarizer provided on the first incident surface, and a first phase retarder provided on the surface of the combined lens facing the reflection mirror; the first polarizer has a thickness of T1 mm, and the first phase retarder has a thickness of T2 mm;
the third compensating lens has a thickness of T1 mm+2T2 mm; and
the fourth compensating lens has a thickness of T1 mm+2T2 mm.

12. The optical module of claim 1, wherein the combined lens comprises a first flat glass and a second flat glass which form an angle therebetween, and one end of the first flat glass is attached to one end of the second flat glass.

13. The optical module of claim 12, characterized in that wherein each of the first flat glass and the second flat glass is provided with a film layer.

14. The optical module of claim 1, wherein the optical path processing assembly further comprises an adjustment lens in the proximity of the emergent surface.

15. An electronic device, comprising a lens and an optical module of claim 1, the lens being provided in the proximity of the emergent surface.
